(19) United States
(12) Patent Application Publication
(10) Pub. No.: US 2011/0083492 A1
(43) Pub. Date: Apr. 14, 2011

(54) Leakage Detection Device

(76) Inventor: An-Chao CHANG, Kueishan Hsiang (TW)

(21) Appl. No.: 12/256,261

(22) Filed: Oct. 22, 2008

(51) Int. Cl. G01M 3/28

(52) U.S. Cl. 73/40.5 R

(57) ABSTRACT

A leakage detection device includes a housing having a front hole at the front side for guiding in air and an exhaust hole at the rear side for exhaust of air, a sensor mounted in the housing in air communication with the front hole for detecting the presence of a coolant in the intake flow of air, and a fan assembly mounted in the housing for drawing outside air to flow through the front hole, the sensor and the exhaust hole, and a cable connectable to a digital coolant pressure gauge for transmitting power supply from the digital coolant pressure gauge to the fan assembly and the sensor and for transmitting an output signal from the sensor to the digital coolant pressure gauge for indication.

### BACKGROUND OF THE INVENTION

1. Field of the Invention

The present invention relates to a cooler examination apparatus and more specifically, to a leakage detection device for detecting a leakage of the coolant circulation loop of an air conditioner.

2. Description of the Related Art

An air conditioner uses a coolant to provide cool air, transferring the produced heat to means that dissipates the heat. In an air conditioner, the coolant is circulating through a circulation loop. In case of a leakage of the coolant circulation loop, the cooling performance of the air conditioner is lowered. In this case, the leakage point on the coolant circulation loop must be quickly detected and sealed, avoiding wasting of the coolant. A coolant leakage detection method is known by means of drawing the coolant away from the coolant circulation loop to keep the coolant circulation loop in a vacuum status and then measuring the negative pressure status of the coolant circulation loop after a predetermined time interval. In case a drop of the negative pressure is measured, a leakage status is determined. This method can simply detect a leakage of the coolant circulation loop without allocating the leakage point. Further, drawing the coolant out of the coolant circulation loop requires much time and labor. There is known another coolant leakage detection method for detecting a leakage on a coolant circulation loop. According to this method, a fluorescent substance is added to the coolant. Under the radiation of a fluorescent lamp, any leakage on the coolant circulation loop can be seen clearly. However, this method requires a fluorescent lamp, increasing the detection cost. Further, the fluorescent lamp must be connected to an external power source, causing inconvenience to the user.

Therefore, it is desirable to provide a leakage detection device that eliminates the aforesaid problems.

### SUMMARY OF THE INVENTION

The present invention has been accomplished under the circumstances in view. It is one object of the present invention to provide a leakage detection device, which is practical for detecting a leakage of the coolant circulation loop of an air conditioner and its location. It is another object of the present invention to provide a leakage detection device for detecting a leakage of a coolant circulation loop of an air conditioner, which saves much detection time and labor.

To achieve these and other objects of the present invention, the leakage detection device comprises a housing, which comprises a front hole in a front end thereof for guiding in air and an exhaust hole in a rear end thereof for exhaust of air, a sensor, which is mounted inside the housing and adapted for detecting the presence of a coolant in air and providing an output signal subject to the detection result, a fan assembly, which is mounted inside the housing in proximity to the back side of the base of the sensor remote from the front hole of the housing for drawing outside air through the sensor, and a cable electrically connectable to a digital coolant pressure gauge for transmitting the output signal of the sensor to the digital coolant pressure gauge and transmitting power supply from the digital coolant pressure gauge to the fan assembly and the sensor.

### BRIEF DESCRIPTION OF THE DRAWINGS

FIG. 1 is an elevational view of a leakage detection device in accordance with the present invention.

FIG. 2 is a cutaway view, in an enlarged scale, of the leakage detection device shown in FIG. 1.

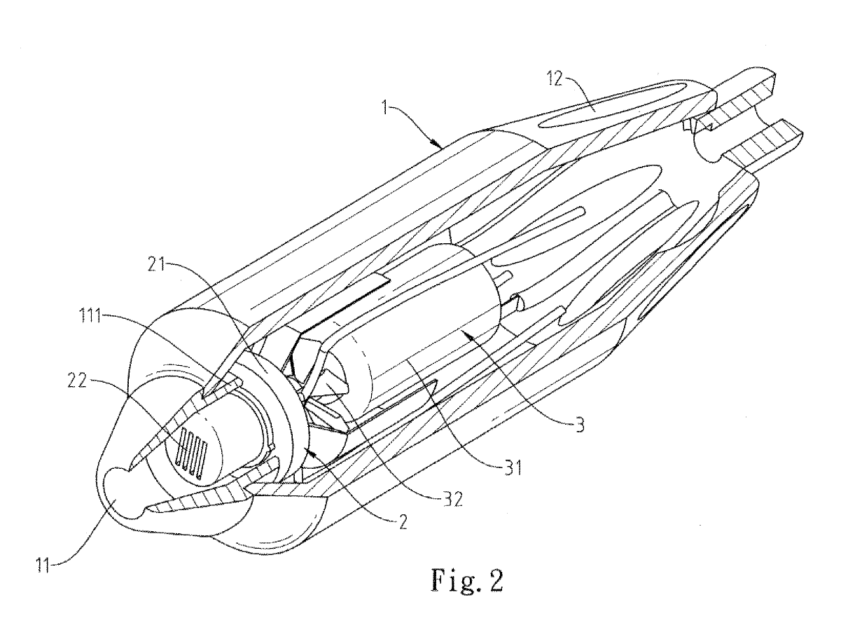

FIG. 3 is an exploded view of a part of the leakage detection device according to the present invention.

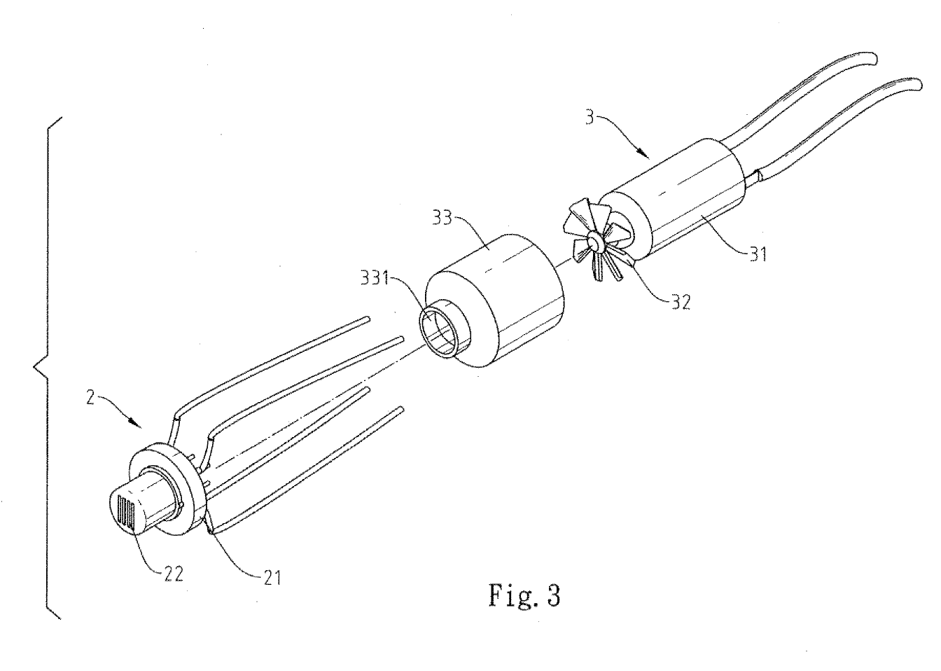

FIG. 4 is an elevational view of a coolant pressure gauge for use with the leakage detection device according to the present invention.

FIG. 5 is an elevational view of a detection lamp set according to the present invention.

### DETAILED DESCRIPTION OF THE PREFERRED EMBODIMENT

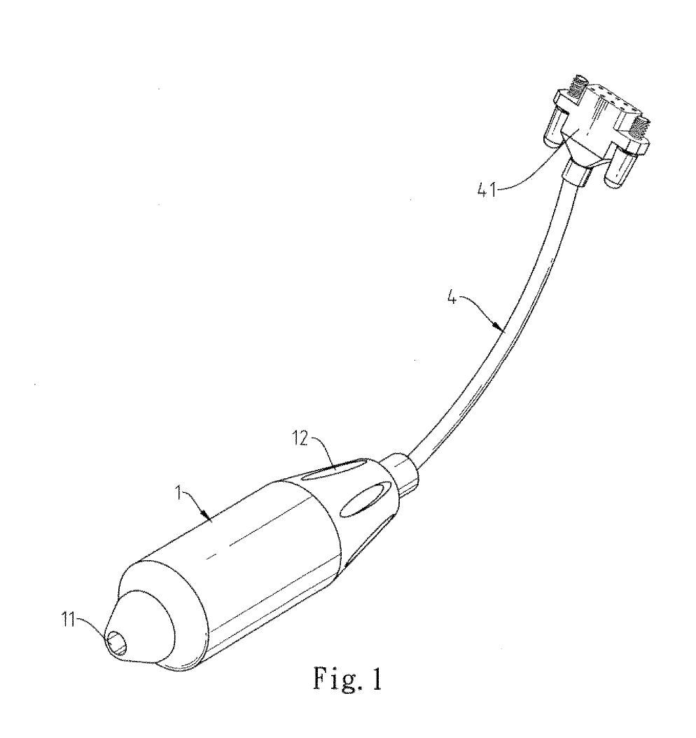

Referring to FIGS. 1˜3, a leakage detection device in accordance with the present invention is shown comprising a housing 1, a sensor 2, a fan assembly 3, and a cable 4.

The housing 1 has a front hole 11 formed in one end, namely, the front end, an exhaust hole 12 disposed near the other end, namely, the rear end, and an inside flange 111 backwardly extended from the inside wall around the front hole 11.

The sensor 2 is mounted inside the housing 1, comprising a base 21 stopped at the rear side of the inside flange 111 of the housing 1, and an air inlet 22 disposed in communication with the front hole 11.

The fan assembly 3 is mounted inside the housing 1, comprising a motor 31, a blade 32 coupled to and rotatable by the motor 31, and a cap 33 surrounding the blade 32. The cap 33 has a suction hole 331 formed in the front side and disposed in proximity to the back side of the base 21 of the sensor 2.

The transmission cable 4 is electrically connected with its one end to the sensor 2 and the fan assembly 3, having an electrical connector 41 provided at its opposite end.

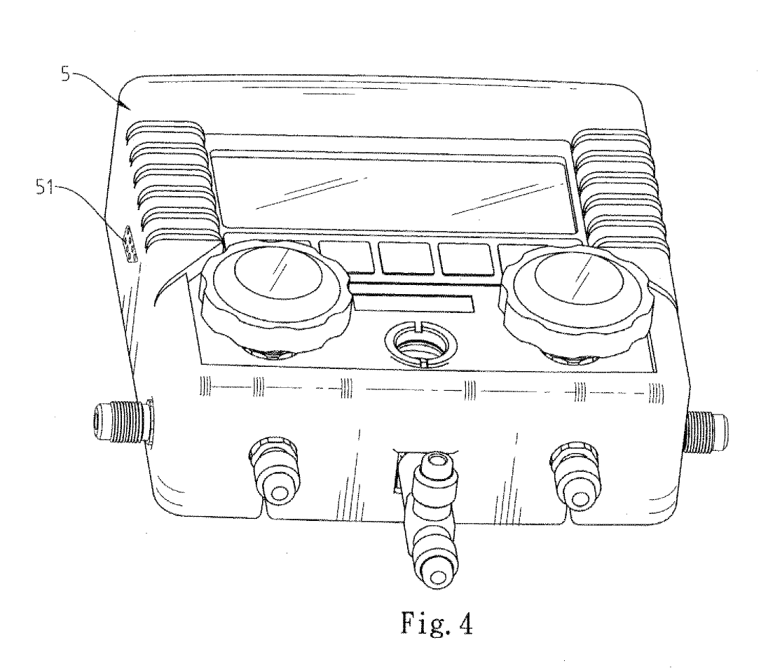

Referring to FIG. 4 and FIGS. 1˜3 again, the electrical connector 41 of the cable 4 is connected to a signal input jack 51 of a digital coolant pressure gauge 5. At this time, the digital coolant pressure gauge 5 provides the sensor 2 and the fan assembly 3 with the necessary working voltage. When the fan assembly 3 is electrically connected, the motor 31 is started to rotate the blade 32, thereby producing a suction force. As stated above, the cap 33 surrounds the blade 32 and has its suction hole 331 disposed in proximity to the back side of the base 21 of the sensor 2. At this time, outside air is sucked through the front hole 11 into the air inlet 22 of the sensor 2 and then into the inside of the housing 1 via the base 21 of the sensor 2 for exhaust through the exhaust hole 12. Thus, the user can move the housing 1 to approach the front hole 11 to the coolant circulation loop of the air conditioner to be detected. When a flow of air is passing through the sensor 2 in the housing 1, the sensor 2 analyzes the content of the air, detecting any presence of coolant in the intake flow of air. When the sensor 2 detected a presence of coolant in the intake flow of air, it immediately outputs a signal to the digital coolant pressure gauge 5 through the cable 4 for indication, enabling the user to know the location of a leakage. By means of moving the housing 1 over the whole area of the coolant circulation loop, any leakage of the coolant circulation loop is detected.

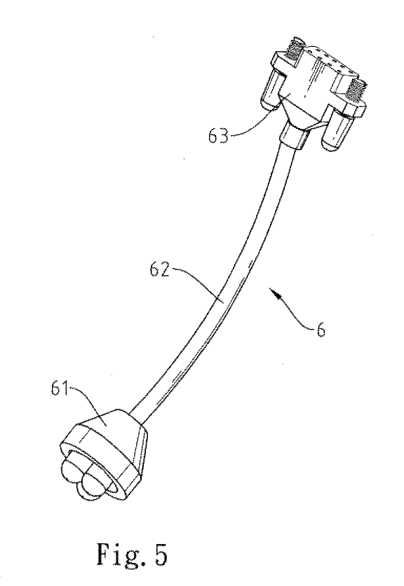

Referring to FIG. 5 and FIG. 4 again, a detection lamp set 6 may be used with the coolant pressure gauge 5. The detection lamp set 6 comprises a light source 61, an electrical connector 63, and a flexible cable 62 connected between the light source 61 and the electrical connector 63. The electrical connector 63 is connectable to the signal input jack 51 of the digital coolant pressure gauge 5 for enabling the light source 61 to obtain the necessary working voltage from the digital coolant pressure gauge 5.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A leakage detection device adapted for detection a leakage on a coolant circulation loop of an air conditioner, said leakage detection device comprising:
a housing, said housing comprising a front hole in a front end thereof for guiding in air and an exhaust hole in a rear end thereof for exhaust of air;
a sensor mounted inside said housing and adapted for detecting the presence of a coolant in air and providing an output signal subject to the detection result, said sensor comprising a base stopped inside said housing adjacent to said front hole, an air inlet disposed in communication with said front hole for guiding in air from said front hole;
a fan assembly mounted inside said housing in proximity to a back side of said base of said sensor remote from said front hole of said housing and adapted for drawing outside air through said front hole of said housing and said sensor for detection by said sensor; and
a cable, said cable comprising a first end electrically connected to said fan assembly and said sensor and an electrical connector provided at a second end thereof and electrically connectable to a signal input jack of a digital coolant pressure gauge for enabling said cable to transmit the output signal of said sensor to the digital coolant pressure gauge and to transmit a power supply from the digital coolant pressure gauge to said fan assembly and said sensor.

2. The leakage detection device as claimed in claim 1, wherein said housing comprises an inside flange extending backwardly from an inside wall thereof around said front hole and stopped against a front side of said base of said sensor.

3. The leakage detection device as claimed in claim 1, wherein said fan assembly comprises a motor, a blade coupled to said motor and rotatable by said motor, and a hook surrounding said blade, said cap comprising a suction hole attached to a back side of said base of said sensor for sucking in air from said front hole of said housing and said air inlet of said sensor upon rotation of said blade by said motor.

4. The leakage detection device as claimed in claim 1, further comprising a detection lamp set, said detection lamp set comprising a light source, an electrical connector electrically connectable to a signal input jack of a digital coolant pressure gauge for enabling said light source to obtain a working power supply from the digital coolant pressure gauge, and a flexible cable connected between said light source and said electrical connector.
